(19) United States
(12) Patent Application Publication
(10) Pub. No.: US 2021/0276658 A1
(43) Pub. Date: Sep. 9, 2021

(54) Suspension Handlebar Assembly and Stem for Bicycle

(71) Applicant: Christopher William Huber, San Jose, CA (US)

(72) Inventor: Christopher William Huber, San Jose, CA (US)

(21) Appl. No.: 17/163,340

(22) Filed: Jan. 29, 2021

Related U.S. Application Data
(60) Provisional application No. 62/967,534, filed on Jan. 29, 2020.

(51) Int. Cl. B62K 21/14

(52) U.S. Cl. CPC B62K 21/14

(57) ABSTRACT

A bicycle handlebar stem or stem/handlebar assembly has an inclined linear travel approximately 45 degrees from horizontal. This inclined path mimics a rider's natural arm inclination and pitching moment. 45 degrees is nearly ideal for most dropped bar road bicycles but different style bicycles may have an ideal angle between 30 and 60 degrees.

The present application claims the benefit of priority to U.S. Provisional Patent Application Ser. No. 62/967,534, filed Jan. 29, 2020 for an invention titled “Suspension Handlebar Assembly And Stem For Bicycle” which is currently co-pending, and fully incorporated herein by this reference.

### FIELD OF THE INVENTION

This invention relates to bicycle handlebars and stems, more specifically to bicycle stems designed to cushion road shock to the rider. More specifically, though not exclusively, the present invention relates to a suspension bicycle stem or suspension stem/handlebar unit with a sprung or sprung and damped 30-60 degree inclined linear sliding element.

### BACKGROUND OF THE INVENTION

Bicycles were invented as early as 1885, and consisted at first of a crude implementation of steel wheels propelled by fixed pedals. In the over 150 years since its invention, bicycles have evolved into highly technical mechanical systems incorporating some of the most modern materials technologies, design elements, and creature comforts representative of the best engineering has to offer. Despite these incredible enhancements in bicycle technology, and the keen focus on making the modern bicycle a highly engineered machine capable of surviving incredible physical stresses and prolonged use, the modern day bicycle still has a fundamental challenge. This challenge is not the bicycle itself, rather, the environment in which the bicycle operates.

Bicycles are operated on a variety of surfaces, ranging from finely paved road surfaces, to the most treacherous mountain environments. Across this spectrum of riding surfaces, there are a variety of surfaces that are encountered. For instance, on even the most pristine roadway, there is often a pothole, unmarked transition, or simply poor workmanship, that results in abrupt transitions, bumps, and jolts. Also, when riding in a mountain environment, there are ruts, gulleys, rocks, ridges, and jumps which result in the most challenging rides. Whether it is due to potholes, transitions, poor workmanship, ruts, gulleys, rocks, ridges or jumps, when a bicycle rider experiences these hazards, there is often an abrupt physical shock to the rider.

Many bicycle riders find the road shock transmitted to their hands, arm and bodies objectionable. In addition this road shock slows the bicycle by upsetting forward momentum and generating resistance at the tire contact surface. The shock and discomfort is only exacerbated when riding long distances, or when the rider is caught unaware of the upcoming shock.

There have been quite a few suspension stems in bicycle history attempting to alleviate the shock and discomfort. Most of these suspension stems have been fitted into a handlebar stem and have used a pivot or multiple pivots. However, these prior stems can have awkward travel paths that only compromises a rider's balance and focus when encountering shock and discomfort, and because of the poor alignment and awkward positioning, these prior devices develop looseness and imbalance resulting in trouble controlling the bicycle.

In light of the above it would be advantageous to provide a device that allows even the most exhausted rider to avoid the pain, shock and discomfort of an abrupt event while riding. Further, it would be advantageous to provide a device that would be easily retrofitted to even the most ordinary bicycle to provide the rider with the ability to avoid the shock and discomfort, despite the exhaustion and fatigue that comes with distance rides, or rides in treacherous environments. Further, it would be advantageous to provide a device that is easily manufacturable, comparatively cost effective, and capable of providing a rider with a measure of protection from the unwanted shock and discomfort.

### SUMMARY OF THE INVENTION

This bicycle handlebar stem or stem/handlebar assembly has an inclined linear travel approximately 45 degrees from horizontal. This inclined path mimics a rider's natural arm inclination and pitching moment, 45 degrees is nearly ideal for most dropped bar road bicycles but different style bicycles may have an ideal angle between 30 and 60 degrees.

This handlebar stem or stem/handlebar unit can be manufactured in aluminum, titanium, magnesium or carbon fiber. The inclined sliding element may move on linear roller bearings, ball bearings or specially compounded glide bushings. The sliding element may be sprung with a coil spring or a version of a “leaf” spring, flexible material or elastomers or a combination thereof. In the stem alone embodiment this invention will appear as a conventional stem split along its extension with an inclined linear ramp with guides that allow for precise steering.

In an integrated embodiment the ramp will be incorporated into the forward part of the “stem” with the slider as a part of or directly attached to the handlebar. This invention may be applied to any roadgoing, off road, “gravel” or hybrid bicycle. It provides increased comfort and performance in every application.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

### BRIEF DESCRIPTION OF THE DRAWING

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

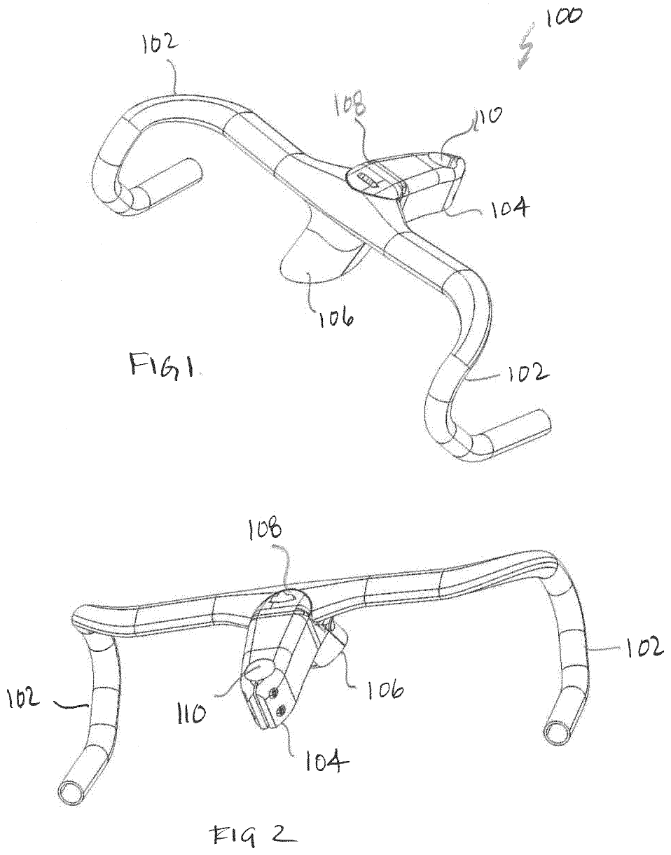

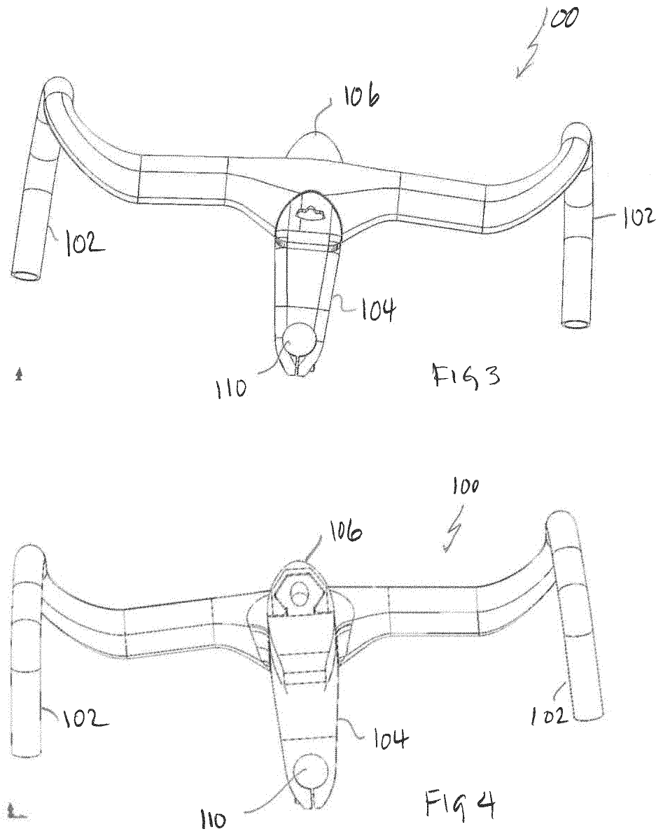

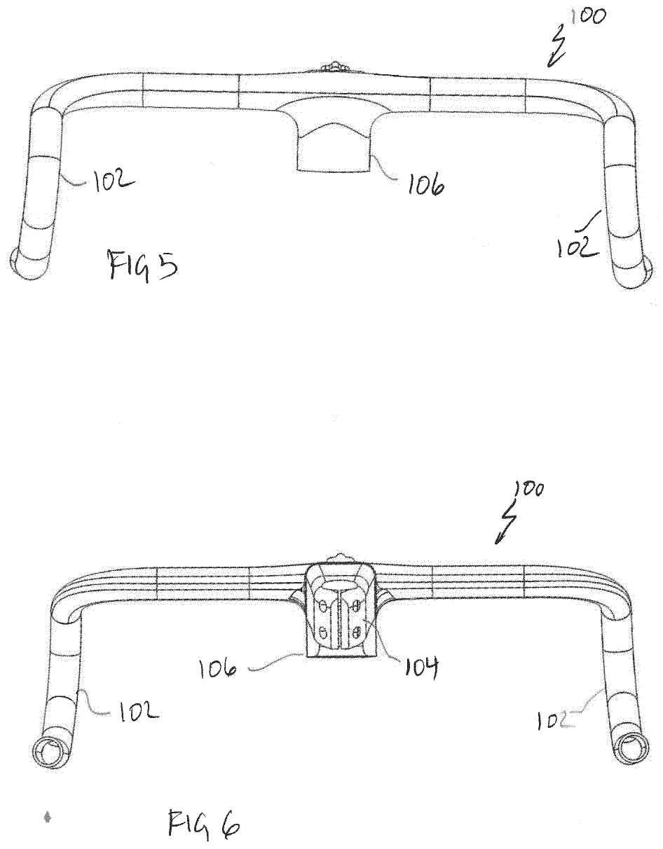

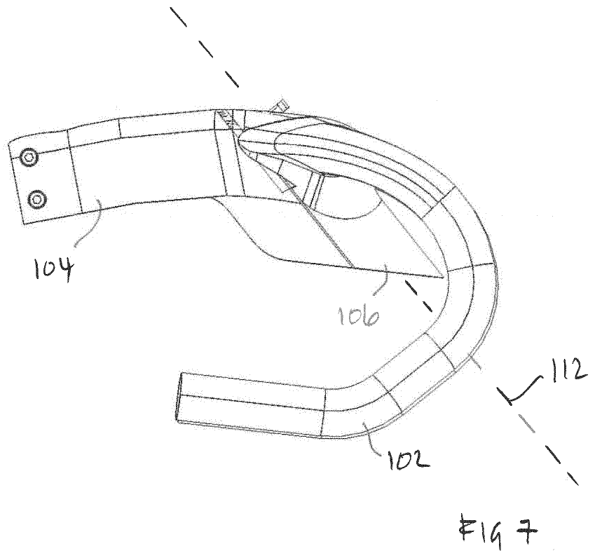

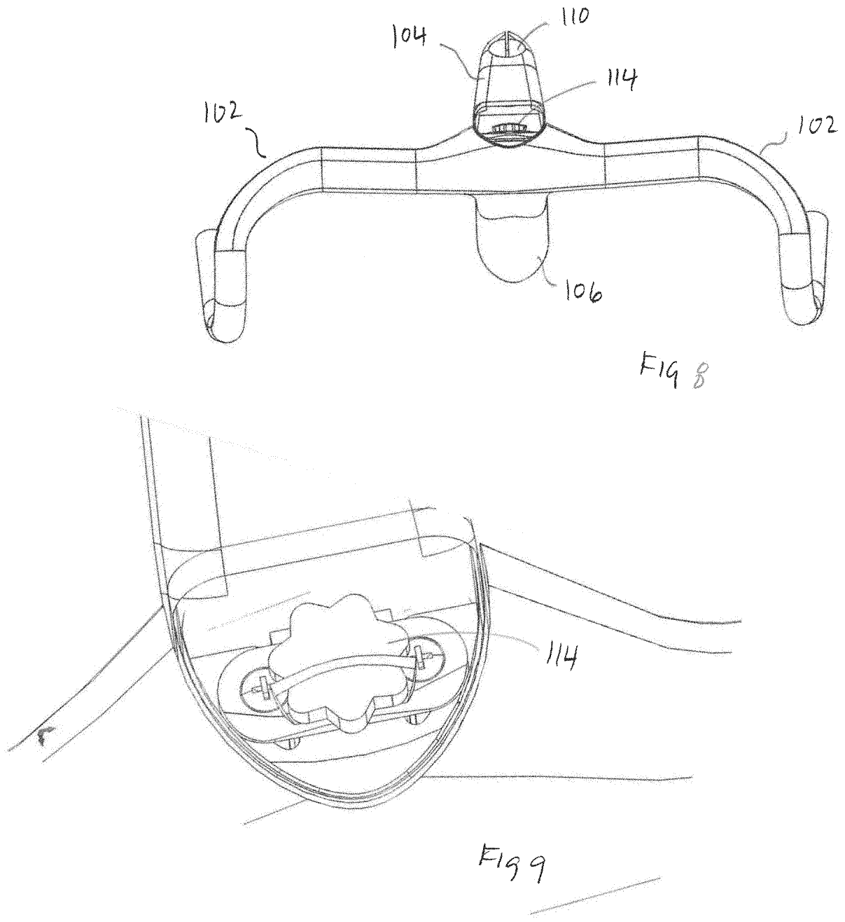

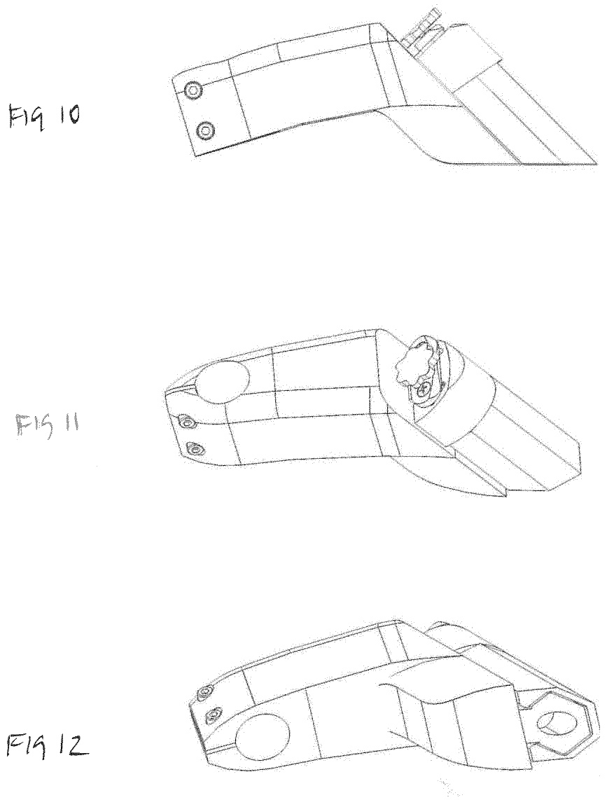

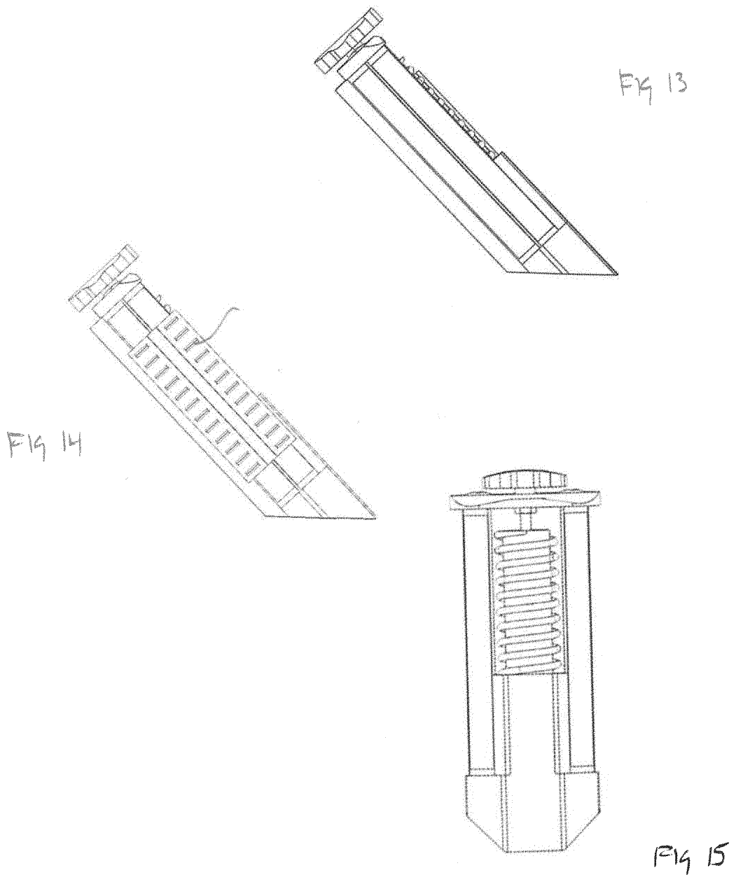

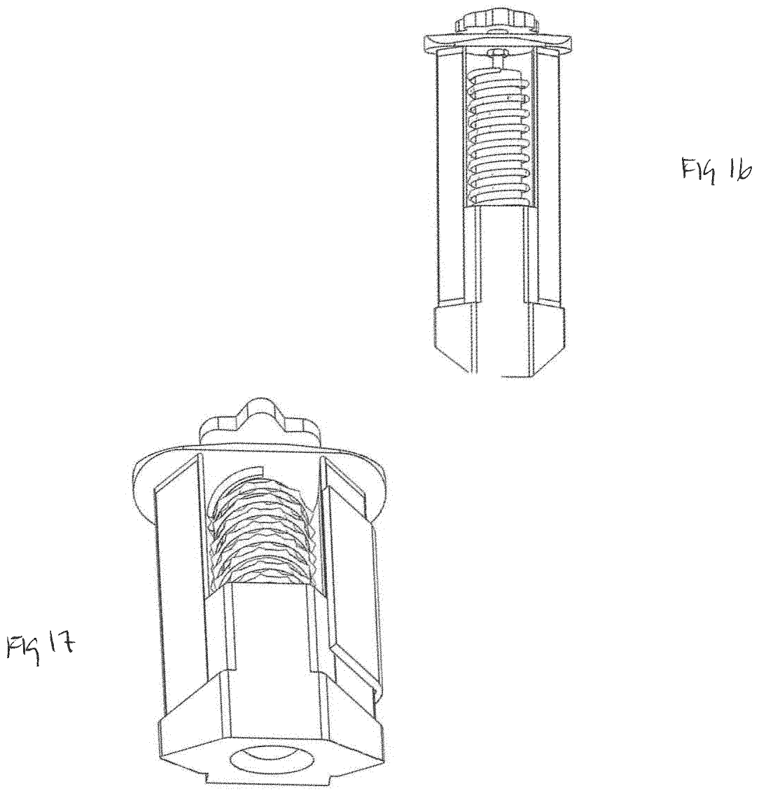

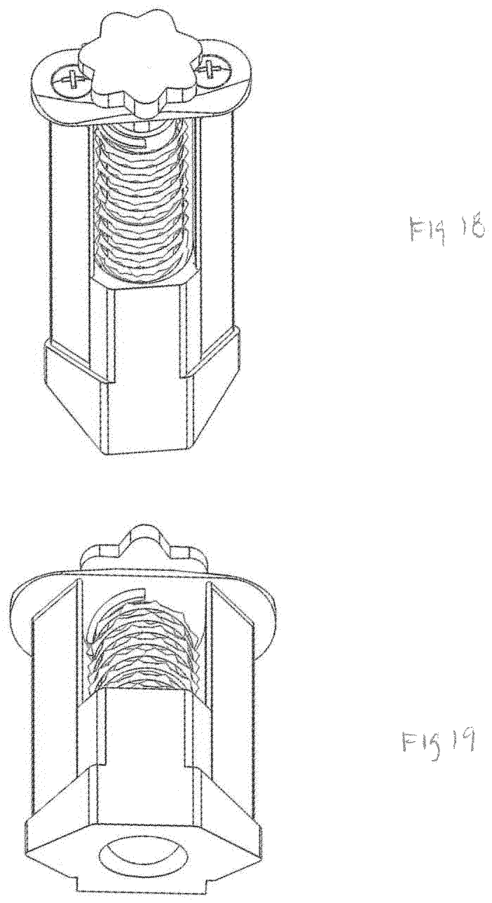

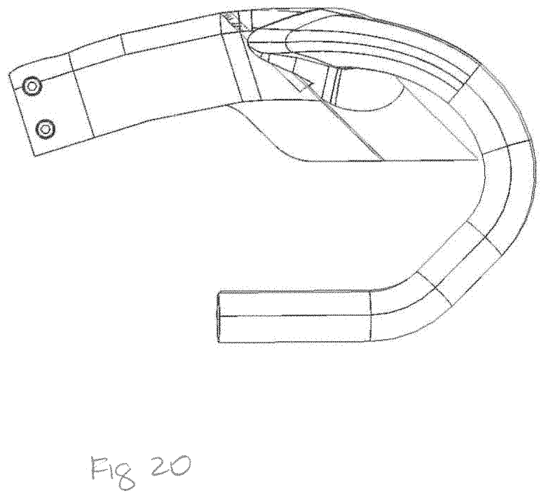

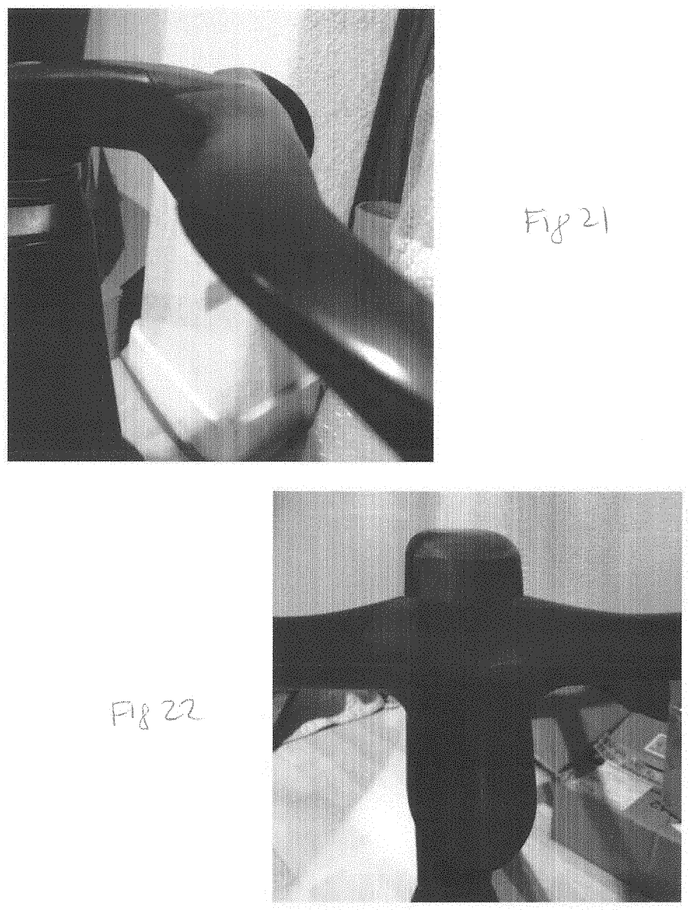

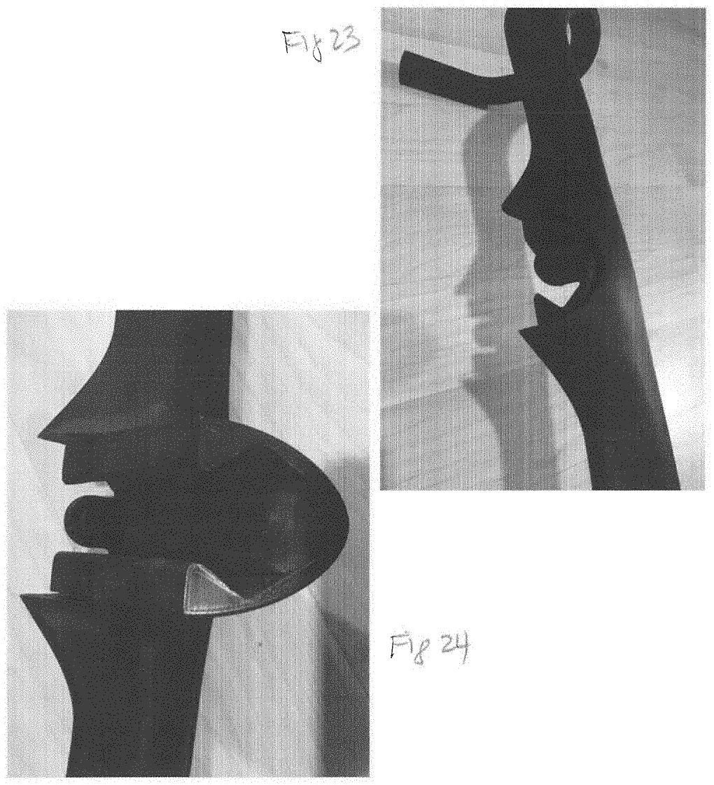

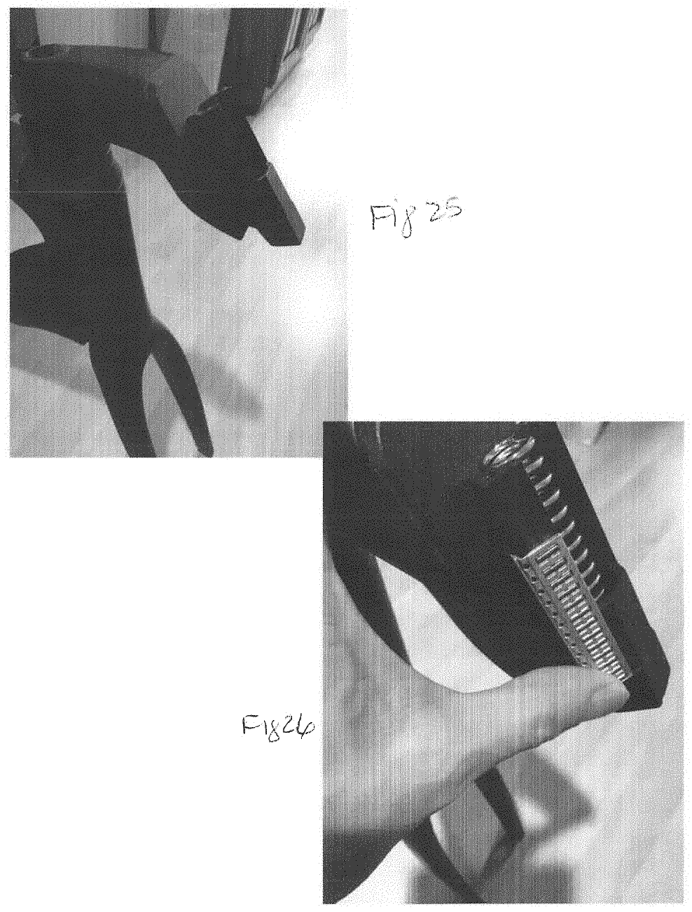

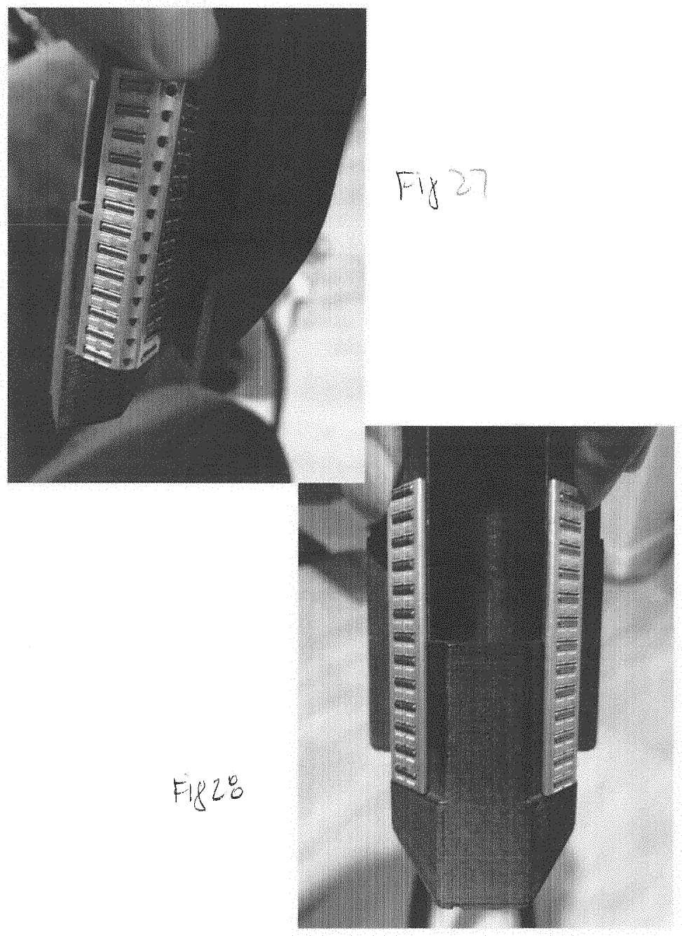

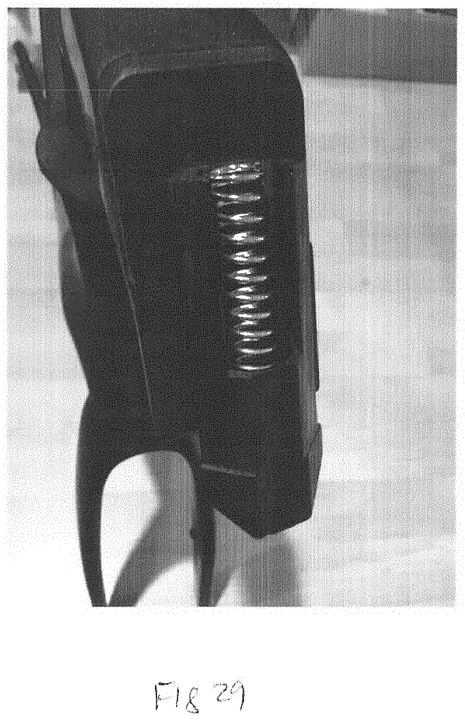

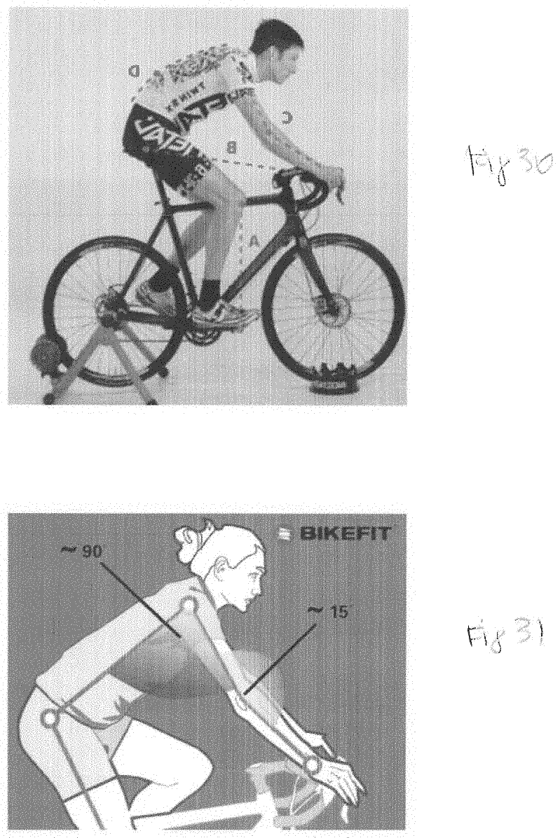

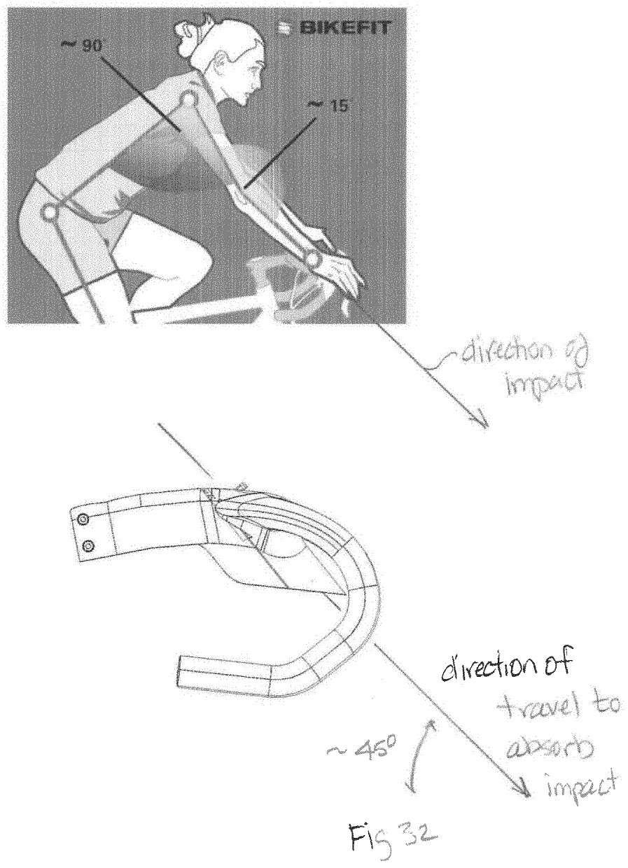

The novel features of this invention, as well as the invention itself, both as to its structure and its operation, will be best understood from the accompanying drawings. FIGS. 1 through 32 depict the present invention in a variety of configurations, and provide detailed images of the components which combine to form the present invention. FIG. 32 depicts the direction of impact for a bicycle rider that encounters an abrupt jolt, and a corresponding bicycle handlebar stem showing the linear travel intended to absorb the linear impact thereby preventing the rider from full exposure of the jolt.

I claim:

1. A bicycle handlebar stem comprising:
a handlebar assembly attachable to the head of a bicycle fork, and a means for an inclined linear travel approximately 45 degrees from horizontal to mimic a rider's natural arm inclination and pitching moment and configured to travel from a first position extended along the length of travel to a second position compressed along the length of travel.
